(19) United States
(12) Patent Application Publication
(10) Pub. No.: US 2025/0004900 A1
(43) Pub. Date: Jan. 2, 2025

(54) IMAGE PROCESSING ACCELERATOR DEVICE AND IMAGE PROCESSING ACCELERATION METHOD

(71) Applicant: SigmaStar Technology Ltd., Xiamen (CN)

(72) Inventors: Jiang-He XU, Xiamen (CN); Qin-Wei SHE, Xiamen (CN); Yan-Xiong WU, Xiamen (CN)

(21) Appl. No.: 18/655,642

(22) Filed: May 6, 2024

(30) Foreign Application Priority Data
Jun. 29, 2023 (CN) 202310791909.2

(51) Int. Cl. G06F 11/30; G06F 9/48

(52) U.S. Cl. CPC G06F 11/3072; G06F 9/485

(57) ABSTRACT

An image processing accelerator device includes a memory, a decoder circuit, an event monitor circuit and a filter control circuit. The memory receives a first command corresponding to a task, and a wait event command which follows the first command. The decoder circuit decodes the first command and the wait event command to determine a register to be accessed in an image processing circuit and first data to be written by the first command, and generates an event identifier. The event monitor circuit determines according to the event identifier whether the image processing circuit has finished executing the task, and accordingly controls the image processing circuit to execute a command corresponding to a next task. The filter control circuit records second data previously stored in the register, and writes the first data to the register when the first data is different from the second data.

This application claims the benefit of China application Serial No. CN202310791909.2, filed on Jun. 29, 2023, the subject matter of which is incorporated herein by reference.

### BACKGROUND OF THE INVENTION

### Field of the Invention

The present application relates to an image processing accelerator device, and more particularly to an image processing accelerator device and acceleration method capable of accelerating update efficiency of registers.

### Description of the Related Art

A current image processing system is usually configured with multiple registers, which can be used to store parameter data (for example, parameters such as resolutions and sizes of images) related to image processing. In some related art, upon receiving an image processing task issued by a processor, an image processing system writes all data provided by the task to corresponding registers. However, some registers may have the same parameter data stored therein. If all of the data of the task is duplicated to corresponding registers, meaningless waste in resources may be resulted. On the other hand, in some related art, once an image processing circuit finishes executing a task, an interrupt needs to be reported to a processor via an image processing system, so that the same channel of the processor can then start executing a next task. The reporting mechanism above needs to wait for a longer period of time before the next task can be executed, hence lowering the overall efficiency of the image processing system.

### SUMMARY OF THE INVENTION

In some embodiments, it is an object of the present application to provide an image processing accelerator device and acceleration method capable of accelerating update efficiency of registers so as to improve the drawbacks of the prior art.

In some embodiments, an image processing accelerator device includes a first memory, a decoder circuit, an event monitor circuit and a filter control circuit. The first memory receives a first command corresponding to a first task, and a wait event command which follows the first command. The decoder circuit decodes the first command to determine a register to be accessed in an image processing circuit and first data to be written to the register by the first command, and decodes the wait event command to generate an event identifier. The event monitor circuit determines according to the event identifier whether the image processing circuit has finished executing the first task, and controls, after determining that the image processing circuit has finished executing the first task, the image processing circuit to execute a second command corresponding to a second task. The filter control circuit records second data previously stored in the register, and writes the first data to the register when the first data is different from the second data.

In some embodiments, the image processing acceleration method includes operations of: receiving a first command corresponding to a first task, and a wait event command following the first command; decoding the first command to determine a register to be accessed in an image processing circuit and first data to be written to the register by the first command, and decoding the wait event command to generate an event identifier; determining according to the event identifier whether the image processing circuit has finished executing the first task, and controlling, after determining that the image processing circuit has finished executing the first task, the image processing circuit to execute a second command corresponding to a second task; and recording second data previously stored in the register, and writing the first data to the register when the first data is different from the second data.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of an image processing accelerator device according to some embodiments of the present application;

FIG. 2 is a schematic diagram of a decoder circuit and an event monitor circuit in FIG. 1 according to some embodiments of the present application;

FIG. 3 is a schematic diagram of a filter control circuit in FIG. 1 according to some embodiments of the present application;

FIG. 4 is an operation timing diagram of the image processing accelerator device in FIG. 1 according to some embodiments of the present application; and

FIG. 5 is a flowchart of an image processing acceleration method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

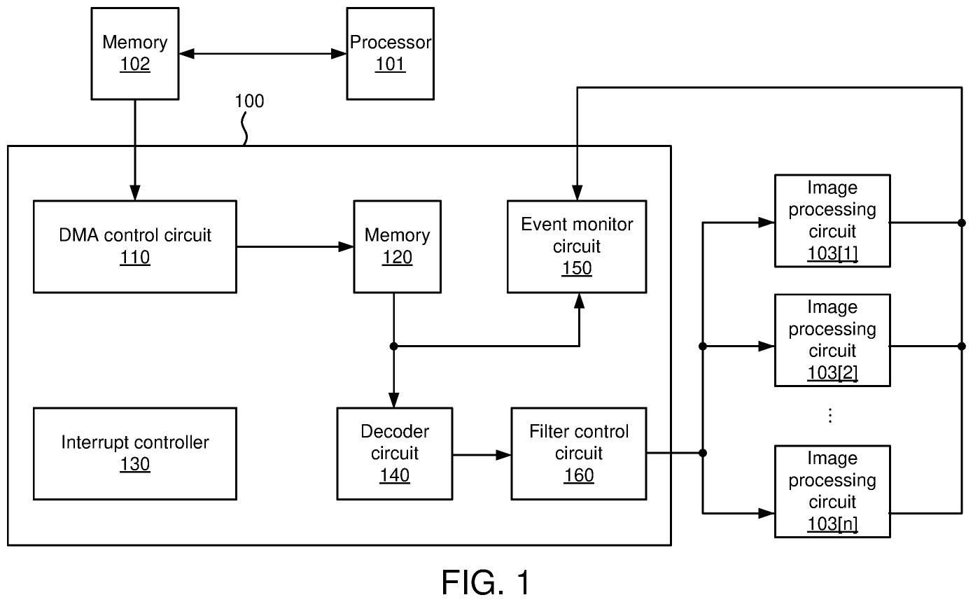

FIG. 1 shows a schematic diagram of an image processing accelerator device 100 according to some embodiments of the present application. In some embodiments, the image processing accelerator device 100 is applicable to electronic systems related to image processing, and is used to assist in enhancing image processing efficiency.

The processor 101 is capable of executing various types of application software, executes a predetermined task (for example but not limited to, processing image data) in response to a request of the application software, and accordingly applies for a temporary storage space in the memory 102 so as to store one or more commands corresponding to the predetermined task. In some embodiments, the processor 101 may be, for example but not limited to, a central processor. In some embodiments, the memory 102 may be, for example but not limited to, a dynamic random access memory (DRAM). The image processing accelerator device 100 may read the command corresponding to the predetermined task from the memory 102, and decode the command to determine whether the predetermined task is to be executed by a corresponding image processing circuit among multiple image processing circuits 103[1] to 103[n], wherein the value n may be a positive integer greater than 1. The image processing accelerator device 100 may further determine multiple registers to be accessed by the predetermined task and whether data to be written to these registers is the same as data currently stored in the registers, so as to filter out registers currently storing the same data. Thus, the image processing accelerator device 100 does not write the data to be written by the predetermined task to the registers currently storing the same data, thereby enhancing the overall processing efficiency.

In some embodiments, the processor 101 may determine scheduling among multiple channels, an image processing algorithm to be used and a configuration of registers, based on a task that an upper-layer application (for example, the application software above) requests to be executed. The processor 101 may encode addresses of the registers to be accessed by the task and the data to be written into multiple command in a predetermined format, for the image processing accelerator device 100 to analyze (or decode) these commands so as to obtain information related the addresses of the registers to be accessed and the data to be written.

In some embodiments, the multiple image processing circuits 103[1] to 103[n] may be circuits related to image processing or application-specific integrated circuits. For example, the image processing circuit 103[1] may be an image signal processor (ISP), the image processing circuit 103[2] may be a lens distortion correction (LDC) circuit, and the image processing circuit 103[n] may be a scaler. It should be noted that the types of the multiple image processing circuits 103[1] to 103[n] described above are merely example and are not to be construed as limitations to the present application. Each of the multiple image processing circuits 103[1] to 103[n] may include multiple registers (not shown), which are used to store related parameter data involved in image processing performed by the corresponding image processing circuit, and may be, for example but not limited to, resolutions, sizes and encoding formats of frames.

In response to the predetermined task assigned by the processor 101, the parameter data of the multiple registers in one corresponding image processing circuit that is selected from the multiple image processing circuits 103[1] to 103[n] to execute the predetermined task can be accordingly updated, so that the corresponding image processing circuit may execute the predetermined task by means of accessing the parameter data in these registers. For example, if the predetermined task assigned by the processor 101 is requesting the image processing circuit 103[1] to perform image processing on one frame, the command corresponding to the predetermined task then includes information of addresses of multiple registers in the image processing circuit 103[1] and parameter data to be written. The image processing accelerator device 100 may analyze the command to obtain the information above, and update the multiple registers in the image processing circuit 103[1] with the parameter data with a related operation to be described below. Thus, the image processing circuit 103[1] may perform image processing according to the parameter data in the multiple registers to thereby complete the predetermined task.

In some embodiments, the processor 102 issues a wait event command after issuing multiple commands corresponding to a predetermined task. That is, the wait event command follows the multiple commands corresponding to the predetermined task. The image processing accelerator device 100 may determine, according to the wait event command, whether the predetermined task has been executed, so as to selectively start executing a next task issued by the processor 101. More specifically, the image processing accelerator device 100 includes a direct memory access (DMA) controller circuit 110, a memory 120, an interrupt controller 130, a decoder circuit 140, an event monitor circuit 150 and a filter control circuit 160.

The DMA controller circuit 110 receives multiple commands corresponding to a first task and a wait event command from the memory 102, and stores all of the commands above to the memory 120. In some embodiments, the memory 126 may be, for example but not limited to, a static random access memory (SRAM).

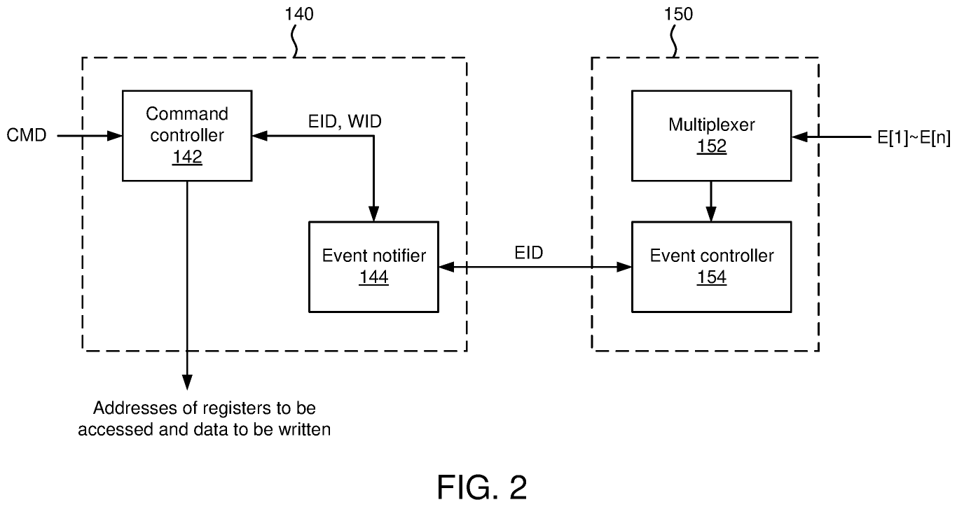

The decoder circuit 140 is coupled to the memory 120, and decodes the commands corresponding to the first task to obtain addresses of registers to be accessed and data to be written by the first task, so as to determine whether the first task is to access the registers of one corresponding among the multiple image processing circuits 130[1] to 130[n] so as to write first data to the multiple registers. On the other hand, the decoder circuit 140 may decode the wait event command to obtain an event identifier (for example, the event identifier EID in FIG. 2) and a wait event identifier (for example, the wait event identifier WID in FIG. 2). The interrupt controller 130 may issue an interrupt to the processor 101 after the one corresponding among the multiple image processing circuits 130[1] to 130[n] has finished executing the first task, so as to notify the processor 101 that the first task has been executed.

The event monitor circuit 150 determines, according to the event identifier, whether the one corresponding among the multiple image processing circuits 130[1] to 130[n] has finished executing the first task, and controls, after determining that the one corresponding among the multiple image processing circuits 130[1] to 130[n] has finished executing the first task, the one corresponding among the multiple image processing circuits 130[1] to 130[n] to execute a command corresponding to a second task. In some embodiments, each of the multiple image processing circuits 130[1] to 130[n] is configured with a corresponding identifier (for example, the identifiers E[1] to E[n] in FIG. 2). Moreover, each of the multiple image processing circuits 130[1] to 130[n] is configured to return the corresponding identifier to the event monitor circuit 150 when it finishes executing a task. Upon receiving the wait event command, the event monitor circuit 150 enters a wait state to monitor the multiple identifiers returned by the multiple image processing circuits 130[1] to 130[n], so as to determine whether these identifiers contain an event identifier that is the same as an event identifier obtained by decoding the wait event command, to further determine whether the one corresponding among the multiple processing circuits 130[1] to 130[n] has finished executing the first task. Related operation details of the above are to be described with reference to FIG. 2 below.

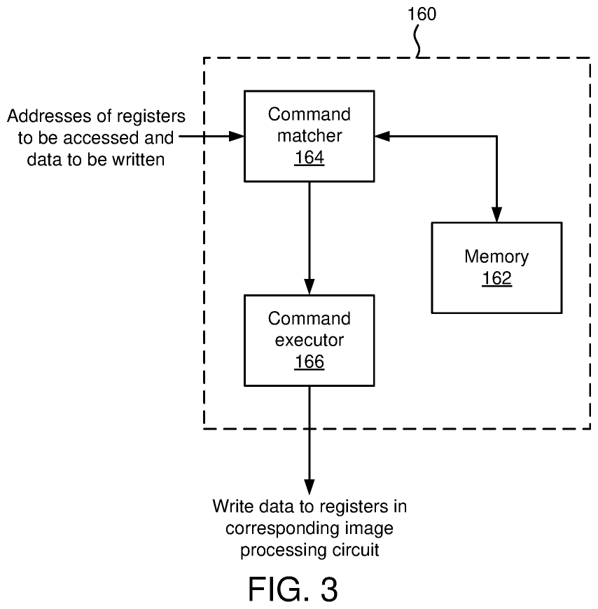

The filter control circuit 160 is coupled to the decoder circuit 140 to receive the commands corresponding to the first task, so as to obtain information of the addresses of the registers to be accessed and the data to be written by the first task. The filter control circuit 160 may record address information of multiple registers of each of the multiple processing circuits 130[1] to 130[n] and data previously stored in each of these registers. The filter control circuit 160 may compare whether the data previously stored in the registers to be accessed by the first task is the same as the data to be written by the first task. If the two are the same, the filter control circuit 160 does not write the data to be written by the first task to the registers. If the data previously stored in the registers to be accessed by the first task is different from the data to be written by the first task, the filter control circuit 160 writes the data to be written by the first task to the registers. Thus, the time used for repeatedly writing the same data to the same register can be eliminated, so as to more quickly allow the multiple processing circuits 130[1] to 130[n] to start performing corresponding image processing, thereby enhancing image processing efficiency. Related operation details of the above are to be described with reference to FIG. 3 below.

FIG. 2 shows a schematic diagram of the decoder circuit 140 and the event monitor circuit 150 in FIG. 1 according to some embodiments of the present application. The decoder circuit 140 includes a command controller 140 and an event notifier 144. The command controller 142 is capable of reading a command CMD from the memory 120 and decoding the command CMD. If the command CMD is a command corresponding to a predetermined task, the command controller 142 may decode the command CMD to obtain related information of addresses of registers to be accessed and data to be written by the predetermined task. The command controller 142 may transmit the related information above to the filter control circuit 160. If the command CMD is a wait event command, the command controller 142 may decode the command CMD to obtain the event identifier EID and the wait command identifier WID. For example, the wait event command may be a 64-bit command, wherein the 32 less significant bits can be used to indicate the event identifier EID, and the 32 more significant bits can be used to indicate the wait command identifier WID. The command controller 142 may determine according to the wait command identifier WID that the command CMD is a wait event command, and transmit the event identifier EID and the wait command identifier WID to the event notifier 144. The event notifier 144 may transmit the event identifier EID to the event monitor circuit 150, and operate in a wait state according to the wait command identifier WID to wait for a response from the event monitor circuit 150.

The event monitor circuit 150 includes a multiplexer 152 and an event controller 154. The multiplexer 152 may be coupled to the multiple image processing circuits 130[1] to 130[n] via a trigger bus, so as to receive multiple identifiers E[1] to E[n] returned from the image processing circuits 130[1] to 130[n]. The event controller 154 may receive the event identifier EID and the multiple identifiers E[1] to E[n], and determine whether any of the multiple identifiers E[1] to E[n] is the same as the event identifier EID, so as to determine whether the one corresponding among the image processing circuits 103[1] to 103[n] has finished executing the predetermined task above.

In some embodiments, the event controller 154 may use a clock signal (not shown) in the system to time a predetermined time, and compare the event identifier EID with the multiple identifiers E[1] to E[n] within the predetermined time, so as to determine whether the one corresponding among the image processing circuits 103[1] to 103[n] has finished executing the predetermined task and to further selectively output a prompt message. Upon expiration of the predetermined time, if the event controller 154 does not detect that any of the multiple identifiers E[1] to E[n] is the same as the event identifier EID, the event controller 154 may report an error to the decoder circuit 140 and issue the prompt message to an upper-layer application, so as to determine to whether continue to execute a next task or again execute the current predetermined task according to control of the upper-layer application. In other words, with the configuration above, the event monitor circuit 150 may start timing the predetermined time upon receiving the event identifier EID. If the event monitor circuit 150 determines that all of the multiple identifiers E[1] to E[n] received are different from the event identifier EID within the specified predetermined time, the event monitor circuit 150 may issue the prompt message to the upper-layer application so as to determine a subsequent operation. Thus, an overly long halt of the system caused by a possible operation error of the image processing system can be prevented.

In some embodiments, each of the command controller 142, the event notifier 144, the multiplexer 152 and the event controller 154 may be implemented by one or more control logic circuits and/or digital circuits, and may execute a predetermined state machine and/or predetermined process to perform related operations of decoding, comparing and monitoring above.

FIG. 3 shows a schematic diagram of the filter control circuit 160 in FIG. 1 according to some embodiments of the present application. The filter control circuit 160 includes a memory 162, a command matcher 164 and a command executor 166. The memory 162 may store addresses of each register in the multiple image processing circuits 103[1] to 103[n] and previously stored data (to be referred to as previous data below). In some embodiments, the memory 162 may be, for example but not limited to, a static random access memory (SRAM).

The command matcher 164 may receive information of the addresses of the registers to be accessed and data (to be referred to as data to be updated below) to be written by a command (for example, the command CMD in FIG. 3) of the predetermined task. The command matcher 164 may search the memory 162 according to the addresses of the registers to be accessed by the command CMD, so as to read the previous data in the registers. The command matcher 164 may accordingly determine whether the previous data is the same as the data to be updated. If the previous data is the same as the data to be updated, it means that the data previously stored in the registers is the same as the new data to be written by the command CMD. In this case, the command matcher 164 does not transmit the addresses of the registers or the data to be updated to the command executor 166. Or, if the previous data is different from the data to be updated, it means that the data previously stored in the registers is different from the new data to be written by the command CMD. In this case, the command matcher 164 stores the data to be updated to the memory 162 to update the memory 162 by replacing the previous data corresponding to the registers with the data to be updated, and provides the addresses of the registers and the data to be updated to the command executor 166. Thus, the command executor 166 may write the data to be updated to corresponding registers of the one corresponding among the multiple image processing circuits 103[1] to 103[n] when the command matcher 164 determines that the previous data is different from the data to be updated, so that the one corresponding among the multiple image processing circuits 103[1] to 103[n] may execute a corresponding task according to the data to be updated in the corresponding registers.

In some embodiments, each of the command matcher 164 and the command executor 166 may be implemented by one or more control logic circuits and/or digital circuits, and may execute a predetermined state machine and/or predetermined process to perform related operations of comparing and updating above.

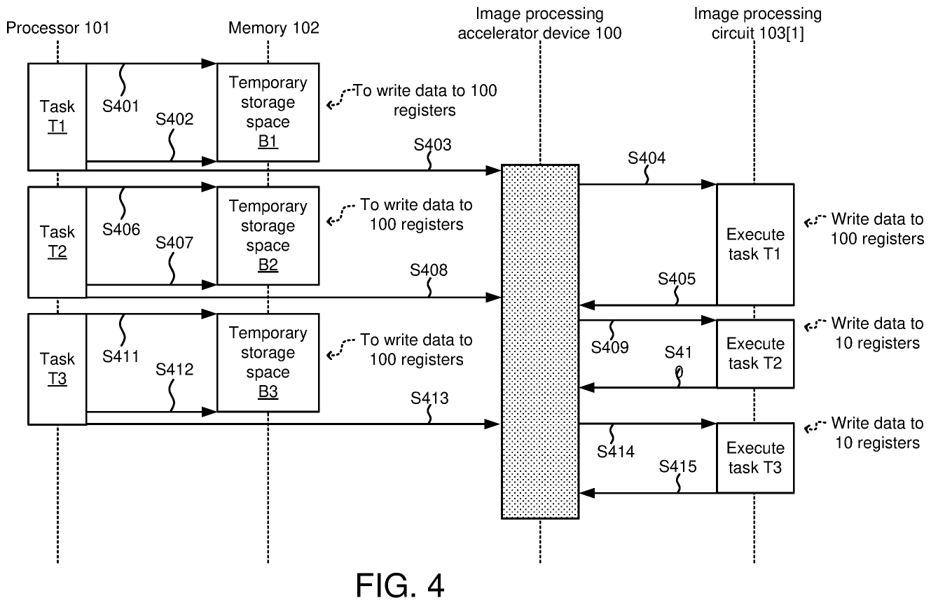

FIG. 4 shows an operation timing diagram of the image processing accelerator device 100 in FIG. 1 according to some embodiments of the present application. As shown in FIG. 4, in response to an upper-layer application, the processor 101 is to execute a task T1, and accordingly applies for a temporary storage space B1 in the memory 102 (operation S401) so as to store multiple commands corresponding to the task T1. The processor 101 further stores a wait event command following the multiple commands corresponding to the task T1 to the temporary storage space B1 (operation S402), and notifies the image processing accelerator device 100 after storing the wait event command (operation S403). In response to the notification from the processor 101, the image processing accelerator device 100 may start reading the multiple commands corresponding to the task T1 and the wait event command from the memory 102. In FIG. 4, a dotted pattern is used to indicate a period in which the image processing accelerator device 100 is in operation. In this example, the task T1 to a task T3 are all assigned to be executed by the image processing circuit 103[1]. The image processing accelerator device 100 may decode the multiple commands of the task T1 to learn that the task T1 is to write first data to 100 registers in the image processing circuit 103[1]. The image processing accelerator device 100 may accordingly write the first data to 100 registers in the image processing circuit 103[1] (operation S404). Next, the image processing accelerator device 100 may decode the wait event command to obtain the corresponding event identifier code EID, and wait for the identifier E[1] that the image processing circuit 103[1] returns after finishing writing the first data to the 100 registers. Once the identifier E[1] the same as the event identifier EID is received, it means that the image processing circuit 103[1] has finished executing the task T1 (operation S405).

On the other hand, during a period in which the image processing circuit 103[1] executes the task T1, the processor 101 additionally applies for another temporary storage space B2 (operation S406) to store multiple commands corresponding to the task T2. The processor 101 further stores a wait event command following the multiple commands corresponding to the task T2 to the temporary storage space B2 (operation S407), and notifies the image processing accelerator device 100 after storing the wait event command (operation S408). Once it is determined that the identifier E[1] the same as the event identifier EID is received, the image processing accelerator device 100 starts decoding the multiple commands corresponding to the task T2, so as to learn about 100 registers in the image processing circuit 103[1] to which second data of the task T2 is to be written. The image processing accelerator device 100 may determine whether the 100 registers are the same as the 100 registers accessed by the task T1. If they are the same registers, the image processing accelerator device 100 may compare whether the first data in these same registers is the same as the second data to be written, and write the second data different from the first data to the corresponding registers (operation S409).

For example, in the task T1, the 100 registers in the image processing circuit 130[1] are written with multiple sets of different first data. After decoding the multiple commands of the task T2, the image processing accelerator device 100 learns that the task T2 is to write multiple sets of different second data to 100 registers in the image processing circuit 103[1]. With filtering of the filter control circuit 160, the image processing accelerator device 100 determines that the first data stored in 90 registers in the image processing circuit 103[1] is the same as the multiple sets of second data to be written by the task T2, and determines that the first data stored in 10 registers in the image processing circuit 103[1] is different from the multiple sets of second data to be written by the task T2. Thus, the image processing accelerator device 100 may then write the second data to only the 10 registers, instead of repeatedly writing all of the second data to the 100 registers. As such, the time used for writing data to registers can be reduced to thereby enhance the overall image processing efficiency.

Next, the image processing accelerator device 100 may decode the wait event command to obtain the corresponding event identifier code EID, and wait for the identifier E[1] that the image processing circuit 103[1] returns after finishing writing the second data to the 100 registers. When the image processing accelerator device 100 receives the identifier E[1] the same as the event identifier EID from the image processing circuit 103[1], it means that the image processing circuit 103[1] has finished executing the task T2 (operation S410).

Based on similar operations, during a period in which the image processing circuit 103[1] executes the tasks T1 and T2, the processor 101 may apply for another temporary storage space B3 to store multiple commands corresponding to a task T3 and notify the image processing accelerator device 100 after storing the wait event command (operation S411 to operation S413). Once it is determined that the identifier E[1] the same as the event identifier EID is received, the image processing accelerator device 100 starts decoding the multiple commands corresponding to the task T3, so as to learn about 100 registers in the image processing circuit 103[1] to which third data of the task T3 is to be written. The image processing accelerator device 100 may determine whether the 100 registers are the same as the 100 registers accessed by the task T1 or the task T2. If they are the same registers, the image processing accelerator device 100 may compare whether data previously stored (which may be the first data or the second data) in these same registers is the same as the third data to be written by the task T3, and write the third data different from the previous data to the corresponding registers (operation S414). For example, the previous data stored in 10 registers in the image processing circuit 103[1] is different from multiple sets of third data to be written by the task T3. Thus, the image processing accelerator device 100 may then write the third data to only the 10 registers. When the image processing circuit 103[1] returns the identifier E[1] the same as the event identifier EID, it means that the image processing circuit 103[1] has finished executing the task T3 (operation S415).

In some actual applications, the task T1 may be performing image processing on a first frame of a video, the task T2 may be performing image processing on a second frame of the video, and the task T3 may be performing image processing on a third frame of the video, wherein the first to third frames are multiple consecutive frames. Since these frames are multiple consecutive frames, changes in scenery details thereof are usually moderate, and so differences in related parameter data (for example but not limited to, resolutions, sizes and contrast) used for image processing of these frame are also moderate. Thus, when the multiple T1 to T3 above are executed, data in the registers in the image processing circuit 130[1] does not change greatly. By determining whether repeated data exists in these registers and accordingly updating registers that contain data changes (instead of writing all data to all registers), the time needed for data update is reduced to thereby save more processing time.

In some related art, once an image processing circuit completes a predetermined task, the image processing circuit reports to a command queuer, an interrupt controller in the queue issues an interrupt to a processor, and the processor then controls the command queuer to start processing a next task upon receiving this interrupt. Compared to the prior art, in some embodiments of the present application, a wait event command is inserted between multiple tasks T1 and T2 or between multiple tasks T2 and T3, so that the image processing accelerator 100 is configured to analyze the event wait command and wait for an identifier returned by a corresponding image processing to further determine whether it can start executing a next task, without involving an notification from the processor 101. Thus, more meaningless wait time can be eliminated and the time to start executing a next task can be advanced, thereby enhancing the overall processing efficiency.

In FIG. 4, an example of related operations of assigning to one image single processing circuit 103[1] is given to describe related operation timings of the image processing accelerator device 100; however, the present application is not limited to the examples above. In some embodiments, the processor 101 may request to simultaneously execute all or part of multiple tasks by means of multiple channels, and accordingly control at least one of the multiple image processing circuits 130[1] to 130[n] by the image processing accelerator device 100 to simultaneously execute all or part of the multiple tasks.

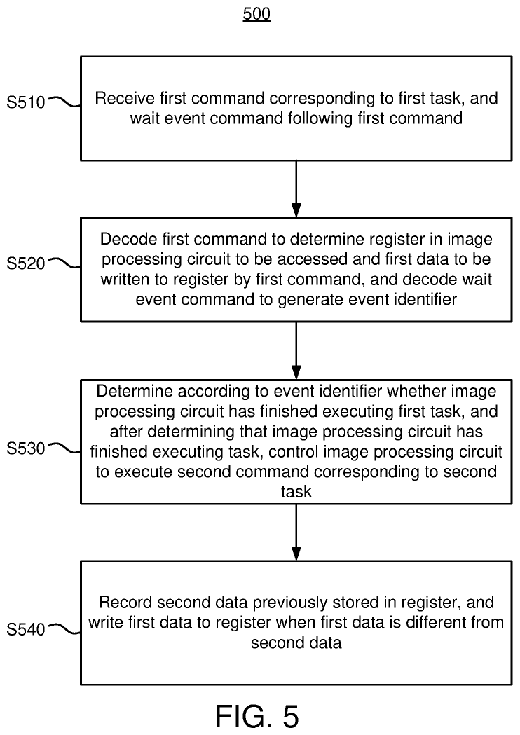

FIG. 5 shows a flowchart of an image processing acceleration method according to some embodiments of the present application. In some embodiments, the image processing acceleration method 500 may be performed by, for example but not limited to, the image processing accelerator device 100 in FIG. 1; however, the present application is not limited to the example above.

In operation S510, a first command corresponding to a first task and a wait event command are received, wherein the wait event command follows the first command. In operation S520, the first command is decoded to determine a register to be accessed in an image processing circuit and first data to be written to the register by the first command, and the wait event command is decoded to generate an event identifier. In operation S530, it is determined according to the event identifier whether the image processing circuit has finished executing the first task, and after determining that the image processing circuit has finished executing the first task, the image processing circuit is controlled to execute a second command corresponding to a second task. In operation S540, second data previously stored in the register is recorded, and the first data is written to the register when the first data is different from the second data.

Details associated with the multiple operations of the image processing acceleration method 500 above can be referred from the details of the embodiments above, and such repeated details are omitted herein. The plurality operations of the image processing acceleration method 500 above are merely examples, and are not limited to being performed in the order specified in this example. Without departing from the operation means and ranges of the various embodiments of the present application, additions, replacements, substitutions or omissions may be made to the operations of the image processing acceleration method 500, or the operations may be performed in different orders (for example, simultaneously performed or partially simultaneously performed).

In conclusion, the image processing accelerator device and the image processing acceleration method according to some embodiments of the present application are capable of reducing the time needed for writing parameter data to registers in an image processing circuit, thereby enhancing the overall image processing efficiency.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. An image processing accelerator device, comprising:
a first memory, receiving a first command corresponding to a first task, and a wait event command which follows the first command;
a decoder circuit, decoding the first command to determine a register to be accessed in an image processing circuit and first data to be written to the register by the first command, and decoding the wait event command to generate an event identifier;
an event monitor circuit, determining according to the event identifier whether the image processing circuit has finished executing the first task, and controlling, after determining that the image processing circuit has finished executing the first task, the image processing circuit to execute a second command corresponding to a second task; and
a filter control circuit, recording second data previously stored in the register, and writing the first data to the register when the first data is different from the second data.

2. The image processing accelerator device according to claim 1, wherein the event monitor circuit compares the event identifier with an identifier returned by the image processing circuit so as to determine whether the image processing circuit has finished executing the first task.

3. The image processing accelerator device according to claim 2, wherein the event monitor circuit further starts to time a predetermined time upon receiving the event identifier, and compares the event identifier with the identifier returned by the image processing circuit within the predetermined time.

4. The image processing accelerator device according to claim 1, wherein the filter control circuit does not write the first data to the register if the first data is same as the second data.

5. The image processing accelerator device according to claim 1, wherein the decoder circuit comprises:
a command controller, receiving the first command and the wait event command from a second memory, decoding the first command to obtain an address of the register and the first data, and decoding the wait event command to obtain the event identifier; and
an event notifier, transmitting the event identifier to the event monitor circuit, and selectively controlling the command controller to start decoding the second command according to a response of the event monitor circuit.

6. The image processing accelerator device according to claim 1, wherein the event monitor circuit comprises:
a multiplexer, receiving an identifier from the image processing circuit; and
an event controller, comparing the identifier from the image processing circuit with the event identifier so as to determine whether the image processing circuit has finished the first task.

7. The image processing accelerator device according to claim 6, wherein the event controller further starts to time a predetermined time upon receiving the event identifier, and compares the event identifier with the identifier returned by the image processing circuit within the predetermined time so as to selectively output a prompt message.

8. The image processing accelerator device according to claim 1, wherein the filter control circuit comprises:
a second memory, storing the address of the register and the second data;
a command matcher, reading the second data from the second memory according to the address of the register, and determining whether the second data is same as the first data; and
a command executor, writing the first data to the register when the command matcher determines that the second data is different from the first data.

9. The image processing accelerator device according to claim 8, wherein the command matcher further writes the first data to the second memory when it is determined that the second data is different from the first data, so as to update the second memory by replacing the second data with the first data.

10. An image processing acceleration method, applied to an image processing accelerator device, the method comprising:
receiving a first command corresponding to a first task, and a wait event command which follows the first command;
decoding the first command to determine a register to be accessed in an image processing circuit and first data to be written to the register by the first command, and decoding the wait event command to generate an event identifier;
determining according to the event identifier whether the image processing circuit has finished executing the first task, and controlling, after determining that the image processing circuit has finished executing the first task, the image processing circuit to execute a second command corresponding to a second task; and
recording second data previously stored in the register, and writing the first data to the register when the first data is different from the second data.
